(19) United States
(12) Patent Application Publication
(10) Pub. No.: US 2026/0270338 A1
(43) Pub. Date: Sep. 10, 2026

(54) Smart Support Pillow Device

(71) Applicant: Karen Puckett, Georgetown, KY (US)

(72) Inventor: Karen Puckett, Georgetown, KY (US)

(21) Appl. No.: 19/233,449

(22) Filed: Jun. 10, 2025

Related U.S. Application Data
(60) Provisional application No. 63/767,199, filed on Mar. 5, 2025.

(51) Int. Cl. H04M 1/04; F16M 13/04

(52) U.S. Cl. CPC H04M 1/04; F16M 13/04

(57) ABSTRACT

A smart device support pillow device is provided. The device has a body configured to support a smart device in either portrait or landscape orientation while the device is positioned on a user’s chest, lap, or a flat surface to facilitate hands-free use. The body may be geometrically triangular and defined by a bottom wall, a first side wall, and a second side wall, with the side walls forming selectable angles relative to the bottom wall to accommodate varying ergonomic needs. Each side wall may incorporate at least one cutout slot designed to securely hold a smart device using friction-enhancing and protective materials such as microfiber or silicone. The first side wall may contain vertically oriented cutout slots, while the second side wall may include horizontally oriented slots, allowing for versatile device orientation.

### CROSS-REFERENCE TO RELATED APPLICATION

The present application claims priority to, and the benefit of, U.S. Provisional Application No. 63/767,199, which was filed on Mar. 5, 2025, and is incorporated herein by reference in its entirety.

### FIELD OF THE INVENTION

The present invention relates generally to the field of pillow devices. More specifically, the present invention relates to a device with a generally triangular body with angled sides having slots to hold a smart device in portrait or landscape orientation for hands-free use. Accordingly, the present disclosure makes specific reference thereto. Nonetheless, it is to be appreciated that aspects of the present invention are also equally applicable to other like applications, devices, and methods of manufacture.

### BACKGROUND

Modern smartphone and smart device usage frequently requires users to maintain their devices at specific angles and distances to ensure optimal screen visibility. This necessity often leads to extended periods of holding the phone in hand, particularly when consuming multimedia content, reading, or engaging in video communication. Such prolonged and repetitive positions place undue strain on the wrists, arms, and shoulders. Over time, this strain may contribute to the development of musculoskeletal conditions, including carpal tunnel syndrome and tendonitis. Furthermore, users attempting to operate their phones while reclining or lying down face additional risks. In such positions, the phone may be inadvertently dropped onto the user’s face or chest, leading to minor injuries or discomfort. These issues highlight the ergonomic challenges associated with conventional handheld smart device use, especially during prolonged sessions. While some accessories exist to facilitate hands-free usage, many lack the adaptability or ergonomic design necessary for body-supported environments like a lap or chest.

Therefore, there exists a long-felt need in the art for a smart device support pillow device that enables secure, hands-free positioning of a smartphone or tablet in ergonomic orientations. There also exists a long-felt need in the art for a smart device support pillow device that allows for both portrait and landscape viewing without requiring manual adjustments. Moreover, there exists a long-felt need in the art for a smart device support pillow device that minimizes physical strain and reduces the risk of accidental device drops during use in reclined or lying positions.

The subject matter disclosed and claimed herein, in one embodiment thereof, comprises a smart device support pillow device. The device is comprised of a body configured to support a smart device in either portrait or landscape orientation while the device is positioned on a user’s chest, lap, or a flat surface to facilitate hands-free use. The body may be geometrically triangular and defined by a bottom wall, a first side wall, and a second side wall, with the side walls forming selectable angles relative to the bottom wall to accommodate varying ergonomic needs. Each side wall may incorporate at least one cutout slot designed to securely hold a smart device using friction-enhancing and protective materials such as microfiber or silicone. The first side wall may contain vertically oriented cutout slots, while the second side wall may include horizontally oriented slots, allowing for versatile device orientation. The bottom wall may include a grip element comprised of tacky materials such as thermoplastic elastomers to improve surface stability. In some embodiments, a thermal dissipation layer may be integrated into the bottom wall to enhance comfort during prolonged use. The body may be encased in a removable outer cover composed of breathable and soft textiles, with integrated closure mechanisms and non-slip textures applied to high-contact areas to prevent displacement. The entire assembly is designed to conform to various human body contours or stationary surfaces while maintaining stable and ergonomic smart device positioning.

In this manner, the smart device support pillow device of the present invention accomplishes all the forgoing objectives and provides a hands-free, ergonomic solution for supporting smart devices during extended use. The inclined angular geometry and dual-orientation slots directly address the need for adjustable viewing positions, while the cushioning materials and integrated grip elements reduce the risk of discomfort and device instability. The inclusion of non-slip textures and thermal dissipation layers further enhances safety and prolonged usability, especially in reclined positions where accidental drops and heat buildup are prevalent concerns. By aligning with the user’s natural visual axis and reducing biomechanical strain on the upper limbs, the device substantially mitigates the risks associated with traditional handheld smart device usage, offering a more accessible and comfortable experience across various usage scenarios.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a smart device support pillow device. The device supports a smart device in either portrait or landscape orientation and may be positioned on a user’s chest, lap, or flat surface for hands-free viewing. The configuration enhances ergonomic alignment and stability for body-supported and stationary use.

The device is comprised of a body defined by a bottom wall, a first side wall, and a second side wall. The first and second side walls may form independently adjustable angles relative to the bottom wall to optimize viewing angles. These configurations allow alignment with the user’s visual field when used on various support surfaces. The bottom wall may be flat.

The body may be me from cushioning materials such as memory foam or composite substrates, selected for their ability to conform to varying surfaces and return to their original shape, enabling adaptive and stable support. The geometric profile of the body may elevate one end of the supported smart device, improving head and neck posture and reducing musculoskeletal discomfort. The angular configuration of the side walls may be symmetric or asymmetric to support different user postures and preferences.

Each side wall may include at least one cutout slot for secure placement of the smart device. These slots may be recessed and lined with friction-enhancing and protective materials such as microfiber or silicone to prevent slippage and abrasion. The slots may be oriented vertically on the first side wall and horizontally on the second side wall, enabling switching between portrait and landscape viewing modes depending on user needs.

The bottom wall may include a grip element comprising high-tack materials such as silicone rubber or thermoplastic elastomers to enhance stability on various surfaces. A thermal dissipation layer may be further integrated into the bottom wall, utilizing materials such as phase-change compounds or breathable textiles to manage heat buildup during prolonged body contact.

The body may be enclosed in a removable outer cover fabricated from breathable, skin-compatible textiles. The cover may be secured with closure mechanisms such as zippers or hook-and-loop fasteners for easy removal and maintenance. The outer cover may include integrated non-slip textures comprised of materials such as silicone rubber or polymer coatings, applied in patterns to increase stability during inclined use.

The invention further includes a method of use comprising the steps of providing the device with the specified components, placing a smart device within a cutout slot in either side wall for portrait or landscape orientation, positioning the device on a user’s body or a flat surface for hands-free viewing, adjusting the angular position by selecting between the angled side walls, and optionally removing and reattaching the outer cover for washing or maintenance.

Accordingly, the smart device support pillow device of the present invention is particularly advantageous as it provides a hands-free, ergonomic solution for supporting smart devices during extended use. The inclined angular geometry and dual-orientation slots directly address the need for adjustable viewing positions, while the cushioning materials and integrated grip elements reduce the risk of discomfort and device instability. The inclusion of non-slip textures and thermal dissipation layers further enhances safety and prolonged usability, especially in reclined positions where accidental drops and heat buildup are prevalent concerns. Therefore, by aligning with the user’s natural visual axis and reducing biomechanical strain on the upper limbs the device substantially mitigates the risks associated with traditional handheld smart device usage, offering a more accessible and comfortable experience across various usage scenarios.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front and rear perspective views of one potential embodiment of a smart device support pillow device of the present invention while receiving and supporting smart devices in accordance with the disclosed architecture;

FIG. 2 illustrates a perspective view of one potential embodiment of a smart device support pillow device of the present invention while receiving and supporting a smart device while a user is using the device in accordance with the disclosed architecture;

FIG. 3 illustrates a perspective view of one potential embodiment of a smart device support pillow device of the present invention in accordance with the disclosed architecture; and

FIG. 4 illustrates a flowchart of a method of using one potential embodiment of a smart device support pillow device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a smart device support pillow device that enables secure, hands-free positioning of a smartphone or tablet in ergonomic orientations. There also exists a long-felt need in the art for a smart device support pillow device that allows for both portrait and landscape viewing without requiring manual adjustments. Moreover, there exists a long-felt need in the art for a smart device support pillow device that minimizes physical strain and reduces the risk of accidental device drops during use in reclined or lying positions.

The present invention, in one exemplary embodiment, is comprised of a smart device support pillow device. The device supports a smart device in either portrait or landscape orientation, which may be placed on the chest, lap, or a flat surface to enable hands-free use. This configuration enhances both ergonomic alignment and stability during body-supported and stationary usage.

The device includes a body defined by a bottom wall, a first side wall, and a second side wall. To optimize viewing angles, the first and second side walls may be positioned at independently adjustable angles relative to the bottom wall. These angular configurations permit alignment with the user's visual field across a variety of support surfaces. The bottom wall may be formed as a flat surface.

The body may be made from cushioning materials, such as memory foam or composite substrates. The geometric profile of the body may elevate one end of the supported smart device, promoting improved neck and head posture and decreasing musculoskeletal strain. To support varying user preferences and postural needs, the side walls may be symmetrically or asymmetrically angled.

At least one cutout slot may be integrated into each side wall to secure the smart device. The slots may be recessed and lined with materials such as microfiber or silicone that increase friction and provide surface protection. In one embodiment, vertically oriented slots may be positioned on the first side wall, while horizontally oriented slots may be located on the second side wall, facilitating alternation between portrait and landscape orientations based on user requirements.

A grip element may be incorporated into the bottom wall and may include high-tack materials such as silicone rubber or thermoplastic elastomers to provide stability on smooth surfaces. Additionally, a thermal dissipation layer may be integrated into the bottom wall and may utilize phase-change materials or breathable textiles to reduce heat accumulation during prolonged body contact.

An outer cover may enclose the body and may be constructed from breathable, skin-compatible textiles. This cover may be removably attached using closure mechanisms such as zippers or hook-and-loop fasteners to allow for maintenance. Integrated non-slip textures, made from materials like silicone rubber or polymer coatings, may be patterned across selected areas of the cover to increase grip when the device is used on angled surfaces.

A method of use includes providing the device with the specified structural components, placing a smart device into a cutout slot in either side wall for portrait or landscape viewing, positioning the device on a user’s body or a flat surface, adjusting the viewing angle by selecting the desired side wall, and optionally removing the outer cover for washing or maintenance.

As a result, the device offers a hands-free, ergonomic solution for extended smart device use. The inclined angular geometry and dual-orientation slots enable flexible viewing adjustments, while the cushioning structure and grip features reduce discomfort and prevent device displacement. Non-slip textures and thermal dissipation layers enhance safety and comfort, especially in reclined conditions where heat and accidental drops are common. Accordingly, the device improves visual alignment and reduces upper limb strain, supporting a more accessible and comfortable user experience across multiple smart device usage scenarios.

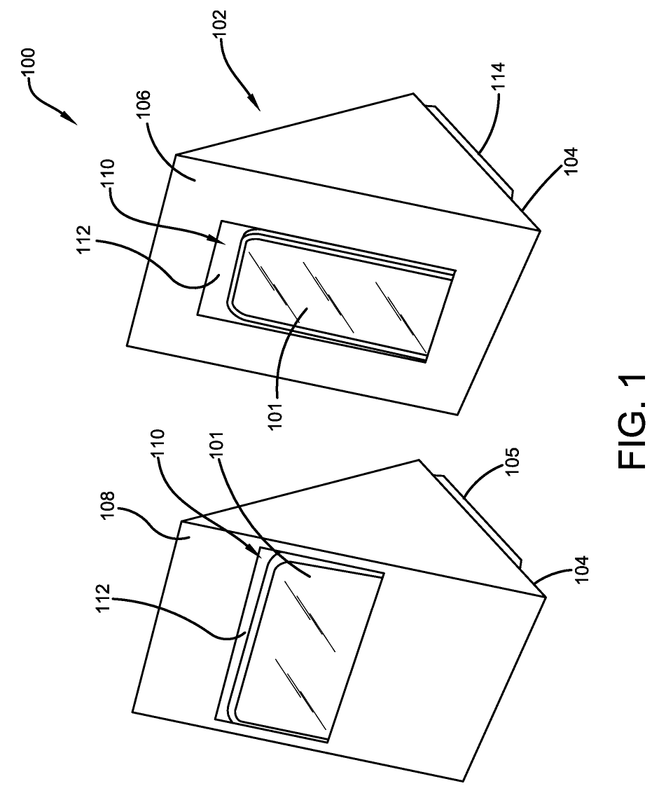

Referring initially to the drawings, FIG. 1 illustrates a front and rear perspective views of one potential embodiment of a smart device support pillow device 100 of the present invention while receiving and supporting smart devices 101 in accordance with the disclosed architecture. The device 100 supports a smart device 101 in either portrait or landscape orientation, wherein the device 100 can be positioned on a user’s chest, lap, or a flat surface to enable hands-free viewing, reducing physical strain and improving comfort during extended use. The design promotes ergonomic alignment and stability across multiple body-supported and stationary platforms.

The device 100 may be comprised of a body 102. In one embodiment, the body 102 is geometrically triangular and may be defined by a bottom wall 104, a first side wall 106, and a second side wall 108. The first side wall 106 and the second side wall 108 may each form an angle with respect to a horizontal axis of the bottom wall 104. The angles of the first side wall 106 and the second side wall 108 relative to the horizontal axis of the bottom wall 104 may independently vary within a range from 1 degree to 90 degrees. These angular relationships may be selectively configured to optimize the viewing angle of a mobile device 101, such as but not limited to a smartphone, a tablet, etc., that is positioned on either wall 106,108. When the device 100 is situated on user-contact surfaces including a lap, chest, abdomen, or proximate horizontal planes such as a table, bed, or recliner, these orientations may enable clear line-of-sight alignment with the user’s natural visual field. The bottom wall 104 may be flat in one embodiment.

The body 102 may be fabricated from cushioning or conformable materials such as but not limited to high-density memory foam, open-cell polyurethane foam, viscoelastic foam, multi-layered composite substrates, etc. These materials may be selected for their ability to deform under pressure while returning to their original shape, thereby enabling stable yet adaptive support on variable contours of the human body or uneven surfaces.

The inclined geometric profile of the body 102 may serve to elevate one end of the mobile device 101 relative to the surface plane the device 100 is being used on, thereby enhancing ergonomic positioning while using the device 101. This elevation may reduce cervical strain by aligning the user’s head and neck posture more neutrally with the screen, improving alignment with the user’s natural visual axis, and facilitating extended periods of device usage with reduced musculoskeletal discomfort. The angular configuration of the first side wall 106 and the second side wall 108 may be symmetric or asymmetric in various embodiments to accommodate user preferences, anatomical differences, and use-case specific posture requirements. For instance, a shallower angle may facilitate reading while lying flat, while a steeper angle may be preferred during seated or semi-reclined usage.

Each of the first side wall 106 and second side wall 108 may be comprised of at least one cutout slot 110, as seen in FIG. 1. The cutout slot 110 may be dimensioned to securely accommodate a smart device 101 in various orientations. The slots 110 may be recessed below the plane of the side walls 106 and 108 to enable secure placement and minimize the likelihood of the device 101 sliding or shifting during use. The interior surface 112 of each cutout slot 110 may include a material comprised of protective and friction-enhancing materials such as but not limited to microfiber, silicone, felt, a textured thermoplastic elastomer, etc., to minimize device abrasion, enhance grip, and prevent slippage.

The cutout slot 110 may be formed in multiple orientations including vertical and horizontal configurations. In one embodiment, vertically oriented cutout slots 110 may be disposed on the first side wall 106, while horizontally oriented cutout slots 110 may be disposed on the second side wall 108. This arrangement allows the user to alternate between portrait and landscape viewing modes based on content type, ergonomic preference, or interactive task (e.g., reading, video conferencing, multimedia consumption).

The bottom wall 104 may be comprised of a grip element 105, which may enhance the frictional interface between the device 100 and underlying support surfaces. The grip element 105 may be comprised of materials such as but not limited to silicone rubber, thermoplastic elastomers, or elastomeric pads that provide high surface tackiness. These materials may be patterned or textured materials further enhance stability on slick or inclined surfaces.

In some embodiments, the bottom wall 104 may additionally include a thermal dissipation layer 114 comprised of phase-change materials, breathable mesh, conductive foam, or thermally conductive textiles. This layer 114 may facilitate heat dissipation when the device 100 is in prolonged contact with the user's body, reducing the risk of thermal discomfort and promoting sustained comfort during extended periods of use.

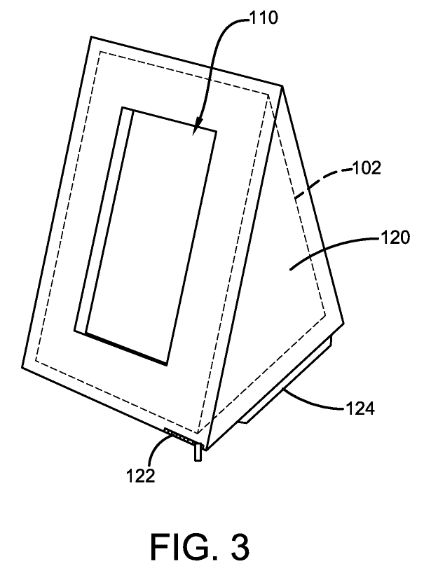

The body 102 may be enclosed within an outer cover 120 in one embodiment, as seen in FIG. 3, wherein the outer cover 120 may be comprised of soft, breathable, and skin-compatible textiles such as but not limited to cotton, polyester blends, synthetic velour, modal, jersey knit, etc. In some embodiments, the outer cover 120 may be removable from around the body 102 and washable. Attachment of the cover 120 around the body 102 may be achieved via closure mechanisms 122 such as concealed zippers, hook-and-loop fasteners, stretchable hems, magnetically secured flaps, or snap buttons, each selected for ease of removal and reattachment without compromising fit.

The outer cover 120 may further include integrated non-slip textures 124 on selected surfaces to provide additional stability on slick or angled surfaces. The textures 124 may include but are not limited to silicone rubber, thermoplastic elastomers, or high-friction polymer coatings, which may be molded or applied in the form of ridges, dimples, grooves, lattice grids, etc. These textures may be located on zones of high contact pressure or tilt-prone areas of the device 100 to counteract slippage during inclined use.

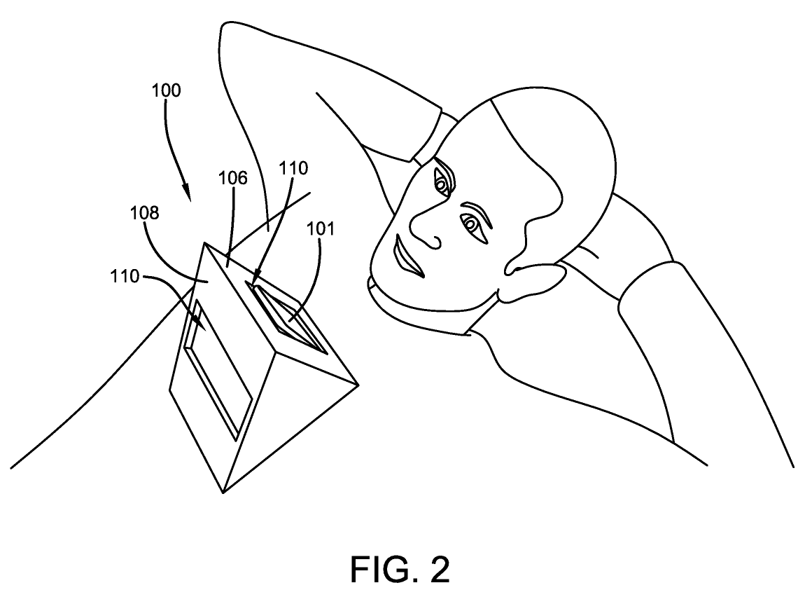

Using the device 100 to support and view a smart device 101 (as seen in FIG. 2) thereby minimizes biomechanical strain on the upper extremities, including wrists, elbows, and shoulders. The elevated viewing angle and passive support may reduce the need for active gripping of the device 101, thereby decreasing fatigue and strain associated with extended device 101 usage. As a result, the device 100 may offer a particular benefit to users experiencing repetitive strain injuries or musculoskeletal conditions such as but not limited to carpal tunnel syndrome, tendinitis, thoracic outlet syndrome, or cervical spondylosis. This ergonomic benefit may enhance accessibility for individuals with reduced grip strength or limited upper limb mobility.

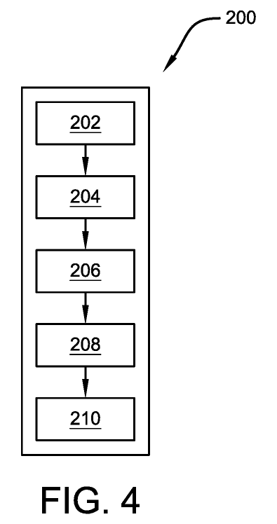

The present invention is also comprised of a method of using 200 the device 100, as seen in FIG. 4. First, a device 100 (in one embodiment) is provided comprised of a body 102, wherein the body 102 is defined by a bottom wall 104, a first side wall 106, and a second side wall 108, and further includes at least one cutout slot 110 in each of the first side wall 106 and the second side wall 108, a grip element 105 on the bottom wall 104, a thermal dissipation layer 114, and an outer cover 120 having integrated non-slip textures 124 and closure mechanisms 122 [Step 202]. Then, a smart device 101 can be placed within a selected cutout slot 110 disposed on either the first side wall 106 or the second side wall 108, thereby supporting the smart device 101 in a desired orientation selected from portrait or landscape [Step 204]. Next, the device 100 can be positioned on a support surface selected from a user’s chest, lap, abdomen, or a horizontal platform such as a table, bed, or recliner to enable hands-free viewing of the smart device 101 wherein a user can view the smart device 101 while supported by the device 100 [Step 206]. Afterward, the user may optionally adjust the angular position of the device 100 by selecting between the first side wall 106 or the second side wall 108, wherein each side wall is angled independently with respect to the horizontal axis of the bottom wall 104 to optimize ergonomic alignment [Step 208]. Finally, following a usage period, the outer cover 120 may be removed via the closure mechanisms 122 for washing or maintenance, and then reattached to the body 102 for continued use [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “smart device support pillow device” and “device” are interchangeable and refer to the smart device support pillow device 100 of the present invention.

Notwithstanding the forgoing, the smart device support pillow device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the smart device support pillow device 100 as shown in the FIGS. are for illustrative purposes only, and that many other sizes and shapes of the smart device support pillow device 100 are well within the scope of the present disclosure. Although the dimensions of the smart device support pillow device 100 are important design parameters for user convenience, the smart device support pillow device 100 may be of any size, shape, and/or configuration that ensures optimal performance during use and/or that suits the user’s needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A smart device support pillow device comprising:
a body comprised of a bottom wall;
a first side wall comprised of a first cutout, wherein the first cutout is comprised of a vertical cutout; and
a second side wall comprised of a second cutout, wherein the second cutout is comprised of a horizontal cutout.

2. The smart device support pillow device of claim 1, wherein the bottom wall is comprised of a grip element.

3. The smart device support pillow device of claim 1, wherein the bottom wall is comprised of a thermal dissipation layer.

4. The smart device support pillow device of claim 1, wherein the first cutout is recessed in the first side wall.

5. The smart device support pillow device of claim 1, wherein the second cutout is recessed in the second side wall.

6. A smart device support pillow device comprising:
a body defined by a bottom wall, a first side wall comprised of a first cutout, and a second side wall comprised of a second cutout;
wherein the first side wall forms a first angle relative to a horizontal axis of the bottom wall;
wherein the second side wall forms a second angle relative to the horizontal axis of the bottom wall; and
an outer cover enclosing the body, the outer cover comprising a closure mechanism.

7. The smart device support pillow device of claim 6, wherein the outer cover is comprised of a non-slip texture.

8. The smart device support pillow device of claim 6, wherein the first angle and the second angle are symmetric.

9. The smart device support pillow device of claim 6, wherein the first angle and the second angle are asymmetric.

10. The smart device support pillow device of claim 6, wherein an interior surface of the first cutout is comprised of a microfiber, a silicone, a felt, or a textured thermoplastic elastomer.

11. The smart device support pillow device of claim 6, wherein the bottom wall is comprised of a thermal dissipation layer.

12. The smart device support pillow device of claim 11, wherein the thermal dissipation layer is comprised of a phase-change material, a breathable mesh, a conductive foam, or a thermally conductive textile.

13. The smart device support pillow device of claim 6, wherein the closure mechanism is comprised of a zipper, a hook and loop fastener, a stretchable hem, a magnetically secured flap, or a snap button.

14. The smart device support pillow device of claim 6, wherein the first cutout is recessed in the first side wall.

15. The smart device support pillow device of claim 6, wherein the second cutout is recessed in the second side wall.

16. The smart device support pillow device of claim 6, wherein the body is comprised of a high-density memory foam, an open-cell polyurethane foam, a viscoelastic foam, or a multi-layered composite substrate.

17. The smart device support pillow device of claim 6, wherein the first cutout is comprised of a vertical cutout.

18. The smart device support pillow device of claim 6, wherein the first cutout is comprised of a horizontal cutout.

19. The smart device support pillow device of claim 6, wherein the bottom wall is comprised of a grip element.

20. A method of using a smart device support pillow device, the method comprising the following steps:
providing a smart device support pillow device comprised of a body defined by a bottom wall, a first side wall comprised of a first cutout slot, and a second side wall comprised of a second cutout slot;
placing a smart device within the first cutout or the second cutout slot; and
positioning the smart device support pillow device on a support surface while viewing the smart device.
